(19) United States
(12) Patent Application Publication
(10) Pub. No.: US 2016/0143272 A1
(43) Pub. Date: May 26, 2016

(54) USE OF MODIFIED OIL AND OIL TO IMPROVE THE TREATMENT OF SEEDS

(71) Applicant: JEFF OCHAMPAUGH, RUSSELL, KS (US)

(72) Inventor: JEFF OCHAMPAUGH, RUSSELL, KS (US)

(21) Appl. No.: 14/935,162

(22) Filed: Nov. 6, 2015

Related U.S. Application Data
(60) Provisional application No. 62/077,027, filed on Nov. 7, 2014.

(51) Int. Cl. A01N 25/24; C05G 3/00

(52) U.S. Cl. CPC A01N 25/24; C05G 3/0088

(57) ABSTRACT

An improved process for treating seeds designed to reduce dust-off. The process uses a mixture of modified oil and oil in a treatment slurry to reduce the amount of dust-off caused from abrasion and transport of seeds. The process is designed to be used in combination with various pesticides, nutrients, plant growth promoters, and utility additives.

### BACKGROUND OF THE INVENTION

Seed treatment prior to planting is a commonly used method of protecting seeds and seedlings from pests. In addition, seed treatment has become a popular method of delivery for other agronomic considerations such as nutritional, biological, and plant growth regulating products useful for hastening the germination and growth of newly planted seeds.

Most pesticidal treatment products that are applied to seed involve the application of a liquid pesticide mixture in a slurried form that is atomized and distributed onto the seed using mechanical equipment; once applied to the seed, the liquid treatment then begins to dry on the seed as the seed flows through the treatment process.

The “neat” formulations of the pesticide prior to application typically involve suspensions of active ingredient particles using clays or silicates that suspend and stabilize the active ingredients in the “flowable” liquid formulation. An ideal seed treatment application is one in which the following goal are achieved: 1) treated seed retains the treatment during post treatment packaging, handling and planting processes in order that all treatment is delivered with the seed to the soil seed bed, 2) treated seed flows smoothly through packaging and planting processes, 3) the treatments perform as expected.

There are two well-known methods for treating seed 1) seed coating in which case a controlled application of seed treatment along with powdered solids are “built-up” on the seed and then processed for drying or 2) an atomized liquid application is applied in a single pass and then allowed to dry as treated seed flows through and from the treating system.

While treating seeds using one of these two methods provides advantages, numerous disadvantages have been discovered. One significant disadvantage is dust-off

“DUST-OFF” is a term commonly used within the seed treatment industry to describe the undesirable physical loss of pesticide or other active ingredient from the surface of a treated seed following treatment and prior to being placed in the soil for planting. Dust-off usually occurs when treated seed is handled or moved. This can occur while seed is being packaged for commerce and otherwise transferred with seed conveying systems at any point from where the seed is treated to the point at which the seed is planted in the field. Any physical abrasion of the treated seed, whether it is seed-to-seed or seed upon hard surfaces, can rub off the applied treatment resulting in loss of pesticide active ingredient.

Dust-off results in numerous negative consequences. The first consequence is the loss of active ingredient on the seed surface. This reduces the effectiveness of the seed treatment. Next, dust-off causes environmental damage via the uncontrolled release of pesticides and other chemicals. Dust-off also creates an occupational hazard at every step of the seed handling process. The negative consequences of dust-off are addressed in the American Seed Trade Association's Guide-to-Seed Treatment Stewardship.

The degree of dust-off and susceptibility to dust-off can be impacted by many factors including but not limited to: seed type, treatment type (levels of active ingredients applied), condition of the seed at time of planting (e.g., clean, dirty, dry, etc.), and method of seed treatment application to the seed.

Dust-off in real word conditions can be predicted with a lab testing method in which case a seed is tumbled in a container while a vacuum is pulled through it, collecting dust, if any on a disc of filter paper. Via this method, the amount of dust-off may be quantified.
1. Post Treatment Handling Characteristics. A very significant challenge associated with treated seed is reduced flowability of the seed through conveying, packaging, and planting systems. Treated seed can be sticky, slow to dry, and rough when compared to the un-treated seed condition. The specific types of problems caused by these treated seed conditions then include accumulation of seed treatment residue on seed conveying, packaging and planting machines as well as failure of seed to flow from and through storage bins and packages and planters.
2. Seed treatment slurry. The mixtures of seed treatment slurry that are applied to the seed are typically aqueous based and very concentrated with the seed treatment active ingredients to be applied to the seed. The high degree of concentration is required to achieve delivery of efficacious doses given the limited amount of surface area of the seed which can accept a limited amount of liquid treatment. Under these circumstances, slurries are typically agitated during application to insure that the mix remains homogenous and any additives that are added to the mix must be compatible with the mix and mix performance is challenged by compatibility and/or concentration. With very few exceptions, most all seed treatment products then applied in this way are either in the form of a suspension concentrate which involves the addition of more and more solids, or an aqueous solution which adds to the volume of the mix that must be applied to the seed. Accordingly the use of more solids contributes to the susceptibility to dust-off and the added volume typically slows treatment drying and can further contribute to seed flowability challenges, both of which are described above.

There are many commercial seed treatment additive products (non-pesticidal) or pesticidal products formulated with additives which have been developed for either tank-mixing into the seed treatment slurry described or otherwise used for the purpose of managing the issues of seed retention (dust-off), post treatment handling characteristics (seed flowability and plantability), and for cosmetic and other non-pesticidal purposes. Some examples of these products include the following brands: Treating Solutions Polymer (Keystone), Flo Rite 1127/1706 (BeckerUnderwood/BASF), DISCO Ag Products (Incotec), Silken 5S & Sentry (Precision Laboratories), and SeedKOTE Products (Kannar).

### SUMMARY OF THE INVENTION

The invention reduces dust-off by incorporating a oil mixture into the seed treatment slurry. The oil mixture is comprised of exthoxylated oil and oil. It is not required that the exthoxylated oil and the oil be derived from the same source. Unlike the polymer, resin, and other adhesive type seed coatings the oil mixture of this invention enhances seed treatment coverage, retention, post-treatment handling characteristics, and is broadly compatible in conventional seed treatment slurry mixes.

### DETAILED DESCRIPTION

It was discovered that seeds treated with a slurry comprising at least one active ingredient and an oil mixture comprised of exthoxylated oil and oil exhibited increased flowability and reduced dust-off. Seeds treated with a slurry comprising a combination of exthoxylated oil and oil demonstrated better characteristics than seeds treated with a slurry comprising ethoxylated oil alone and seeds treated with a slurry comprising oil alone.

The initial discovery of this invention specifically involved the combination of ethoxylated soybean oil in combination with a non-specified vegetable oil (coded: AGLEX-KT2) added to a pesticidal seed treatment slurry mix for wheat seed. The initial test involved a tank mix with wheat seed treatment Dividend Extreme [fungicide] (3 oz/cwt)+Cruiser 5FS [insecticide] (1.33 oz/cwt)+Rancona 3.8 [fungicide] (0.051 oz/cwt)+Vibrance [fungicide] (0.08 oz/cwt)+Aglex KT2 (1 oz/cwt)+Water (8.069 oz/cwt) or a total of 13.53 fluid oz of total mix applied per 100 lbs of seed compared to the same without Aglex KT2. Red colorant was also added to the slurry.

Testing demonstrates the visual results of “dust-off” testing which show dramatically reduced levels of “dust-off” when a commercial wheat seed treatment for wheat (Sativa IM Max) was applied in combination with AGLEX-KT2 than without AGLEX-KT2.

In addition to improved dust-off performance when applied with Aglex KT2, it is also noted and clearly observable that the treatment coverage is improved as evidenced by color and visual impression, although both samples received the exact same level of treatment and red colorant included with it.

Further trial use of AGLEX-KT2 (ethoxylated soybean oil in combination with a non-specified vegetable oil) revealed that soybeans treated with a tank mix of Maxim 4FS fungicide, Apron XL fungicide, and Cruiser 5FS insecticide with AGLEX-KT2 additive demonstrated improved post-treatment handling characteristics compared to the tank mixed pesticide treatment without AGLEX-KT2 or vegetable oil alone.

Additionally, observation of treatment slurry remained more stable with the addition of AGLEX-KT2 compared to the same slurry mix without AGLEX-KT2.

Further experimentation revealed an impressive quantifiable reduction in dust-off of active ingredient. Four types of seed (wheat, oats, hulless barley, and hulled barley) were treated with the two treatment slurries described below.

| | | Treatment | Treatment |
|---|---|---|---|
| | | Slurry 1 | Slurry 2 |
| Seed Treatment | Active | (oz/100 lbs | (oz/100 lbs |
| (Brand) | Ingredient/Purpose | of seed) | of seed) |
| Dividend Extreme | Difenoconazole/ | 3.000 | 3.000 |
| | Fungicide | | |
| | Mefenoxam/Fungicide | | |
| Cruiser 5FS | Thiamethoxam/ | 1.330 | 1.330 |
| | Insecticide | | |
| Rancona 3.8 | Ipconazole/Fungicide | 0.051 | 0.051 |
| Vibrance | Sedaxane/Fungicide | 0.080 | 0.080 |
| Ethoxylated oil/ | Retention Additive | 0.000 | 1.000 |
| oil mixture | | | |
| Water | Non-Active/Carrier | 9.069 | 8.069 |
| | Solution | | |

| | | |
|---|---|---|
| Mixed Treatment Application Rate | 13.530 | 13.530 |
| (oz/100 lbs seed) | | |

After the seeds were treated, 100 gram samples of each treated seed were tested for dust-off by tumbling the samples for a period of 2 minutes while applying a vacuum. The vacuum port was covered with filter paper to capture and collect dust-off during tumbling. The filter papers were tested using HPLC methods to determine the amount of active ingredient present on the filter paper. The results are summarized below.

Wheat (Alzada, a drum variety)

| | Seeds | Seeds | |
|---|---|---|---|
| | treated with | treated with | % Dust-off |
| | treatment | treatment | Reduction |
| | slurry 1 - | slurry 2 - | between |
| | micro grams | micro grams | treatment |
| | of active | of active | slurry 1 and |
| | ingredient | ingredient | treatment |
| Active Ingredient | on filter | on filter | slurry 2 |
| Difenoconazole | 115 | 5 | 95.6% |
| Ipconazole | 7 | level below | unable to |
| | | limits of | calculate |
| | | quantization | |
| Mefenoxam | 13 | 2 | 87.8% |
| Sedaxane | 11 | level below | unable to |
| | | limits of | calculate |
| | | quantization | |
| Thiamethoxam | 374 | 9 | 97.6% |
| Total micrograms of | 521 | 16 | 97.0% |
| active ingredient | | | |
| found on filters | | | |

Oats (Everleaf, a spring oat variety)

| | Seeds | Seeds | |
|---|---|---|---|
| | treated with | treated with | % Dust-off |
| | treatment | treatment | Reduction |
| | slurry 1 - | slurry 2 | between |
| | micro grams | micro grams | treatment |
| | of active | of active | slurry 1 and |
| | ingredient | ingredient | treatment |
| Active Ingredient | on filter | on filter | slurry 2 |
| Difenoconazole | 117 | 17 | 90.0% |
| Ipconazole | 9 | 2 | 79.5% |
| Mefenoxam | 39 | 5 | 86.9% |
| Sedaxane | 40 | 2 | 95.4% |
| Thiamethoxam | 1117 | 66 | 94.1% |
| Total micrograms of | 1377 | 92 | 93.3% |
| active ingredient | | | |
| found on filters | | | |

Barley (Champion, a 2-rowed hulled spring variety)

| | Seeds | Seeds | |
|---|---|---|---|
| | treated with | treated with | % Dust-off |
| | treatment | treatment | Reduction |
| | slurry 1 - | slurry 2 | between |
| | micro grams | micro grams | treatment |
| | of active | of active | slurry 1 and |
| | ingredient | ingredient | treatment |
| Active Ingredient | on filter | on filter | slurry 2 |
| Difenoconazole | 64 | 12 | 81.2% |
| Ipconazole | 4 | level below | unable to |
| | | limits of | calculate |
| | | quantization | |
| Mefenoxam | 9 | 4 | 54.7% |
| Sedaxane | 7 | 1 | 84.5% |
| Thiamethoxam | 221 | 37 | 83.5% |
| Total micrograms of | 305 | 54 | 82.4% |
| active ingredient | | | |
| found on filters | | | |

Hulless Barley (BG 012, a hulless, six-rowed, spring,
waxy endosperm variety)

| | Seeds | Seeds | |
|---|---|---|---|
| | treated with | treated with | % Dust-off |
| | treatment | treatment | Reduction |
| | slurry 1 - | slurry 2 | between |
| | micro grams | micro grams | treatment |
| | of active | of active | slurry 1 and |
| | ingredient | ingredient | treatment |
| Active Ingredient | on filter | on filter | slurry 2 |
| Difenoconazole | 120 | 23 | 80.9% |
| Ipconazole | 8 | 2 | 71.9% |
| Mefenoxam | 14 | 5 | 60.5% |
| Sedaxane | 13 | 2 | 80.6% |
| Thiamethoxam | 411 | 78 | 81.0% |
| Total micrograms of | 565 | 111 | 80.4% |
| active ingredient | | | |
| found on filters | | | |

These experimental results show the ethoxylated oil/oil mixture significantly reduces the dust-off of every active ingredient tested. Similar results were found when testing garden beans, black beans, chickpeas, garden peas, kidney beans, and pinto beans. Further testing has shown no ill-effects on the germination or viability rates of treated seeds when using 1 oz or 2 oz of ethoxylated oil/oil mixture per 100 lbs of seed.

### Seed Care Uses of the Invention

While the initial discovery involved the use of AGLEX KT2 mixed with insecticide and fungicide products commonly used for treating wheat and soybeans, the applications of the invention are very broad and wide with respect to managing the aforementioned seed treating challenges.

Any oil may be used, but oils derived from plants are a preferred embodiment. In particular, vegetable oil is a preferred embodiment because it is readily available, safe, and ecologically friendly. Soybean oil is also a preferred embodiment for the same reasons.

Any ethoxylated oil may be used, but ethoxylated oils derived from oils produced by plants are preferred. In particular, ethoxylated soybean oil is a preferred embodiment.

The ratio of ethoxylated oil to oil (i.e., non-ethoxylated oil) in the oil mixture is also important. The ratio of ethoxylated oil to oil may range from a four to one ratio to a one to four ratio. The preferred embodiment is a one to one ratio of ethylated oil to oil.

The amount of oil mixture in the slurry is also important. The typical volume of slurry per one hundred pounds of seeds ranges from 4 to 16 ounces. The preferred embodiment is one ounce of oil mixture per slurry (total volume of 4 to 16 ounces), but as little as 0.5 ounces of oil mixture and as much as two ounces of oil mixture may be used in a slurry (giving a total volume of 4 to 16 ounces).

A slurry also comprises at least one of the following active ingredients: pesticides, nutrients, plant growth promoters, and/or utility additives.

### Pesticides

Pesticides used in the practice of seed care include any type of product used to protect a seed from some type of pest threat or to otherwise manage or influence the survivability or growth characteristics of the seed for which the product has been applied. Pesticides commonly used for seed treatment at the time of this application include insecticides (protection from insects), fungicides (protection from diseases), nematicides (protection from nematodes), and plant growth regulators (influence the growth of the plant). However, the scope of pesticide can be and is much broader than these most commonly used pesticides.

### Types of Pesticides

Pesticides are often referred to according to the type of pest they control. Another way to think about pesticides is to consider those that are chemical pesticides or are derived from a common source or production method. Other categories include biopesticides, antimicrobials, and pest control devices.

### Chemical Pesticides

Some examples of chemically-related pesticides follow.

Organophosphate Pesticides—These pesticides affect the nervous system by disrupting the enzyme that regulates acetylcholine, a neurotransmitter. Most organophosphates are insecticides. They were developed during the early 19th century, but their effects on insects, which are similar to their effects on humans, were discovered in 1932. Some are very poisonous (they were used in World War II as nerve agents). However, they usually are not persistent in the environment.

Carbamate Pesticides affect the nervous system by disrupting an enzyme that regulates acetylcholine, a neurotransmitter. The enzyme effects are usually reversible. There are several subgroups within the carbamates.

Organochlorine Insecticides were commonly used in the past, but many have been removed from the market due to their health and environmental effects and their persistence (e.g. DDT and chlordane).

Pyrethroid Pesticides were developed as a synthetic version of the naturally occurring pesticide pyrethrin, which is found in chrysanthemums. They have been modified to increase their stability in the environment. Some synthetic pyrethroids are toxic to the nervous system.

### Biopesticides

Biopesticides are certain types of pesticides derived from such natural materials as animals, plants, bacteria, and certain minerals. At the end of 2001, there were approximately 195 registered biopesticide active ingredients and 780 products. Biopesticides fall into three major classes:

(1) Microbial pesticides consist of a microorganism (e.g., a bacterium, fungus, virus or protozoan) as the active ingredient. Microbial pesticides can control many different kinds of pests, although each separate active ingredient is relatively specific for its target pest[s]. For example, there are fungi that control certain weeds, and other fungi that kill specific insects.

The most widely used microbial pesticides are subspecies and strains of Bacillus thuringiensis, or Bt. Each strain of this bacterium produces a different mix of proteins, and specifically kills one or a few related species of insect larvae. While some Bt's control moth larvae found on plants, other Bt's are specific for larvae of flies and mosquitoes. The target insect species are determined by whether the particular Bt produces a protein that can bind to a larval gut receptor, thereby causing the insect larvae to starve.

(2) Plant-Incorporated-Protectants (PIPs) are pesticidal substances that plants produce from genetic material that has been added to the plant. For example, scientists can take the gene for the Bt pesticidal protein, and introduce the gene into the plant's own genetic material. Then the plant, instead of the Bt bacterium, manufactures the substance that destroys the pest. The protein and its genetic material, but not the plant itself, are regulated by EPA.

(3) Biochemical pesticides are naturally occurring substances that control pests by non-toxic mechanisms. Conventional pesticides, by contrast, are generally synthetic materials that directly kill or inactivate the pest. Biochemical pesticides include substances, such as insect sex pheromones, that interfere with mating, as well as various scented plant extracts that attract insect pests to traps. Because it is sometimes difficult to determine whether a substance meets the criteria for classification as a biochemical pesticide, EPA has established a special committee to make such decisions.

PEST TYPES
Pesticides that are related because they address
the same type of pests include:

| | |
|---|---|
| Algaecides | Control algae in lakes, canals, swimming |
| | pools, water tanks, and other sites. |
| Antifouling agents | Kill or repel organisms that attach to |
| | underwater surfaces, such as boat bottoms. |
| Antimicrobials | Kill microorganisms (such as bacteria and |
| | viruses). |
| Attractants | Attract pests (for example, to lure an insect or |
| | rodent to a trap). (However, food is not |
| | considered a pesticide when used as an |
| | attractant.) |
| Biopesticides | Biopesticides are certain types of pesticides |
| | derived from such natural materials as animals, |
| | plants, bacteria, and certain minerals. |
| Biocides | Kill microorganisms. |
| Disinfectants and | Kill or inactivate disease-producing |
| sanitizers | microorganisms on inanimate objects. |
| Fungicides | Kill fungi (including blights, mildews, molds, |
| | and rusts). |
| Fumigants | Produce gas or vapor intended to destroy pests |
| | in buildings or soil. |
| Herbicides | Kill weeds and other plants that grow where |
| | they are not wanted. |
| Insecticides | Kill insects and other arthropods. |
| Miticides | Kill mites that feed on plants and animals. |
| (also called acaricides) | |
| Microbial pesticides | Microorganisms that kill, inhibit, or out |
| | compete pests, including insects or other |
| | microorganisms. |
| Molluscicides | Kill snails and slugs. |
| Nematicides | Kill nematodes (microscopic, worm-like |
| | organisms that feed on plant roots). |
| Ovicides | Kill eggs of insects and mites. |
| Pheromones | Biochemicals used to disrupt the mating |
| | behavior of insects. |
| Repellents | Repel pests, including insects (such as |
| | mosquitoes) and birds. |
| Rodenticides | Control mice and other rodents. |

The term pesticide also includes these substances:

| | |
|---|---|
| Defoliants | Cause leaves or other foliage to drop from a |
| | plant, usually to facilitate harvest. |
| Desiccants | Promote drying of living tissues, such as |
| | unwanted plant tops. |
| Insect growth regulators | Disrupt the molting, maturity from pupal stage |
| | to adult, or other life processes of insects. |
| Plant growth regulators | Substances (excluding fertilizers or other plant |
| | nutrients) that alter the expected growth, |
| | flowering, or reproduction rate of plants. |

### Nutrients

Nutrients are defined as any type of plant food material applied to the seed to hasten or promote seed germination and establishment of the new plant.

### Plant Growth Promoters

All other beneficial compounds not included under pesticides or nutrients which include naturally occurring microbes (for example: nitrogen fixing bacteria called inoculants), beneficial fungus (often naturally occurring such as mycrorrihzal fungi which are applied to the seed to improve plant health), signaling compounds, and others.

### Utility Additives Can Also be Used in the Treatment of Seeds

Utility additives may also be added to the slurry, but are not limited to, dyes, pigments and other colorants used to indicate treatment by imparting color to the treated seed, seed lubricants including talc & graphites, or other non-active products used to manage the cosmetic appearance of the treated seed.

These uses could be in combination with any of the above in the three general ways when treating seeds:
1. As a tank-mixed additive where by the oil mixture is added to the treatment mix when needed at the time of the seed treating application.
2. As a pre-mixed component formulated with an EPA registered pesticide.
3. As a pre-mixed component formulated with non-pesticide seed treatment products exempt from EPA registration including any of those mentioned above (nutrient, plant growth promoters, and utility additives).
4. As a component of a custom blended seed treatment mix with EPA registered products and other non-pesticide seed care products.

In experiments, dye was added to the treatment slurry. Dye may be added to the seeds before application of the treatment slurry, after application of the treatment slurry, during the application of the treatment slurry, or it may be incorporated into the treatment slurry itself. In experiments, dye was added at a rate of 0.25 oz. to 1.5 oz. per 100 lbs of seed.

### Seeds

This invention has value for application on any type of commercially grown and sold seed including agricultural crops (including but not limited to corn, soybeans, wheat, rice, barley, edible beans, sugar beets, sorghums, cotton, tobacco, peanuts and others), vegetable crops, turf and ornamentals (including but not limited to grasses, forbes, flowers), and any others in which pesticides or other seed treatments detailed herein are applied to the seed.

This invention is particularly effective when treating seeds that are irregularly shaped, have a porous natural seed coat, or both. Examples of seeds that are irregularly shaped include those seeds with significant irregular wrinkles and/or indentations. Irregular shaped seeds include corn, wheat, and rice. Seeds with a rough or porous natural seed coat include cotton seeds, corn, wheat, and rice.

Experimentation has shown the invention is best suited for cereals, in particular corn, wheat, and rice.

### Seed Treatnent Applicators of the Invention

This invention can be utilized in all types of seed care applications where by the seed treatment (i.e., slurry) as previously described is placed upon the seed by seed growers, seed companies, wholesale resellers/distributors of seed, retailers of seed, or the end user of the seed (typically the grower/farmer/custom farmer/nursery/homeowner/landscaper).

### Seed Treatment Application Methods

The invention can be actuated by various application methods. In one embodiment the formulation is applied via a batch treatment method.

Batch Treatment Method: A pre-measured volume of seed is dosed with the corresponding measured dose rate of the seed treatment (pre-mix/tank-mixed product/custom blend as described above) and then combined/mixed with the seed and then evacuated from the treating device in favor of the next batch to be treated.

Another embodiment of the invention the formulation is applied via a continuous flow method.

Continuous Flow Method: A continuous flowing stream of seed is treated with a continuous flow of treatment (pre-mix/tank-mixed product/custom blend as described above) in which case seed flow rate is calibrated with seed treatment rate to achieve treatment.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

While the present general inventive concept has been fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in seeds, ratios of active ingredients, etc.

It is also to be understood that the following claims are intended to cover all of the generic and specific features of the invention herein described, and all statements of the scope of the invention which, as a matter of language, might be said to fall there between. Hence, the proper scope of the present general inventive concept should be determined only by the broadest interpretation of the appended claims so as to encompass all such modifications as well as all relationships described in the specification. It should also be understood that multiple combinations of dependent claims are also cumulatively and independently disclosed.

Finally, it will be appreciated that the purpose of the annexed Abstract is to enable the U.S. Patent and Trademark Office and the public generally, and especially the scientists, chemist, and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A process for treating seeds comprising contacting said seeds with a slurry comprising an active ingredient and oil mixture wherein said oil mixture comprises ethoxylated oil and oil.

2. The process of claim 1 wherein said ethoxylated oil comprises a plant derived exthoxylated oil.

3. The process of claim 1 wherein said ethoxylated oil is a plant derived ethoxylated oil.

4. The process of claim 1 wherein said ethoxylated oil is ethoxylated soybean oil.

5. The process of claims 3 wherein said oil comprises an oil derived from plants.

6. The process of claims 3 wherein said oil is an oil derived from plants.

7. The process of claims 3 wherein said oil is vegetable oil, soybean oil, castor oil, coconut oil, corn oil, cottonseed oil, false flax oil, hemp oil, mustard oil, palm oil, peanut oil, radish oil, rapeseed oil, famtil oil, rice bran oil, safflower oil, sunflower oil, tong oil, algea oil, copaiba oil, honge oil, jatropha oil, jojoba oil, milk bush oil, petroleum nut oil, or a blend of said oils.

8. The process of claims 3 wherein said oil is vegetable oil.

9. The process of claims 1 wherein said seed is an agriculturally cultivated seed.

10. The process of claims 1 wherein said seed is corn, soybean, cotton, wheat, rice, alfalfa, canola, sorghum, sugar beets, squash, barley, edible beans, tobacco, or peanuts.

11. The process of claims 1 wherein said seed is wheat, corn, or rice.

12. The process of claims 1 wherein said active ingredient comprises pesticides, nutrients, and plant growth promoters.

13. The process of claims 1 wherein said active ingredient comprises pesticide.

14. The process of claims 1 wherein said active ingredient comprises fungicide.

15. The process of claims 1 wherein said formulation further comprises a utility additive.

16. The process of claim 15 wherein said utility additive comprises a colorant.

17. The process of claims 1 wherein the ratio of said exthoxylated oil to said oil in said oil mixture is between four to one and one to four.

18. The process of claims 1 wherein the ratio of said exthoxylated oil to said oil in said oil mixture is between three to one and one to three.

19. The process of claims 1 wherein the ratio of said exthoxylated oil to said oil in said oil mixture is between two to one and one to two.

20. The process of claims 1 wherein the ratio of said exthoxylated oil to said oil in said oil mixture is one to one.
